(19) United States
(12) Patent Application Publication
(10) Pub. No.: US 2012/0127622 A1
(43) Pub. Date: May 24, 2012

(54) TANK-TYPE LIGHTNING ARRESTER

(75) Inventors: Hiroki Kajino, Tokyo (JP); Mitsunori Hama, Tokyo (JP); Hiroki Saito, Tokyo (JP); Koichi Akaso, Tokyo (JP); Shinji Ishibe, Tokyo (JP)

(73) Assignee: MITSUBISHI ELECTRIC CORPORATION, Chiyoda-ku (JP)

(21) Appl. No.: 13/388,321

(22) PCT Filed: Aug. 4, 2010
(86) PCT No.: PCT/JP2010/004892

§ 371 Date: Feb. 1, 2012

(30) Foreign Application Priority Data
Aug. 6, 2009 (JP) 2009-183814

(51) Int. Cl. H02H 3/22

(52) U.S. Cl. 361/117

(57) ABSTRACT

For a tank-type lighting arrester having varistors in a layered manner, it is an object to provide a lightning arrester having a shield in a simple shape, and in such a shape that achieves more uniform voltage distribution among the varistors than that in conventional techniques. In a lightning arrester according to the present invention, layered varistors are provided in a tank in which an insulating medium is filled, and a cylindrical shield is arranged therearound. To solve at least part of the above problems, in the lightning arrester according to the present invention, a plurality of holes are arranged on a side surface of the shield.

### FIELD

The present invention relates to a tank-type lightning arrester that includes varistors, and that is used to protect electric apparatuses from an abnormal voltage intruding into a system at a power plant or a substation.

### BACKGROUND

Lightning arresters are used to protect apparatuses from an abnormal voltage caused by a current of lightning strikes. The lower the voltage at the time when 10 kA flows (referred to as discharge voltage) to a lightning arrester is, the lower the voltage generated in a protection device is. Therefore, as the discharge voltage lowers, a protection device can be formed compact, and it is recognized that the lightning arrester has excellent performance. On the other hand, to a lightning arrester, even when a surge current such as a current of lightning strikes is not flowing, a system voltage is applied to the protection device all the time, and the system voltage is distributed among varistors that are layered inside the lightning arrester. This voltage stress distributed to varistors is required to be equal to or lower than a certain amount in the viewpoint of long-term reliability, and when the varistors of the same size are used, the discharge voltage can be made lowest in the case where the voltage is evenly distributed among the varistors, thereby achieving the enhancement of performance of the lightning arrester.

However, influenced by a current flowing into a tank of ground potential and source through a stray capacitance from the varistors, the voltage distributed to an individual varistor is to be highest at the varistor on a power supply side, and to be lower as the device comes closer to a ground side. Therefore, to enhance the performance of a lightning arrester, it is important to reduce the voltage stress of the varistor on the power supply side, and to make the voltage distributed among individual varistors even.

There are various methods to make the voltage distribution among varistors even, and a method of placing a shield on the power supply side is widely used as one thereof. It is targeted to compensate a current flowing into a tank from varistors to make the voltage distribution among the varistors even, by placing a shield on the power supply side and charging a capacitive current from the shield on the power supply side to the varistors (for example, refer to Patent Literature 1).

### Citation List

### Patent Literature

Patent Literature 1: Japanese Patent No. 3283104

Patent Literature 2: Japanese Patent Application Laid-open No. 2008-306136

Patent Literature 3: Japanese Patent Application Laid-open No. H6-302409

### SUMMARY

### Technical Problem

In a tank-type lightning arrester that has varistors in a layered manner, a shield having shapes as described in U.S. Pat. No. 3,283,104 is sometimes used to make the voltage distribution among varistors even. However, there are such problems in that these shapes make the structure complicated, and make the electric field between the shield and a ground tank nonuniform, and nonuniform electrostatic forces can be applied to the lightning arrester.

Thus, a cylindrical shield that has a simple structure and is to avoid a nonuniform electric field between the shield and a ground tank is sometimes used. When the voltage distribution among varistors is made even by using a cylindrical shield, because the depth of the shield with which the voltage distribution of the varistors is minimized is to be determined if the diameter of the ground tank, the diameter of the shield, and the height of the varistors are determined, the maximum value and the minimum value of the voltage distribution rate exist. Therefore, there has been a problem in that a limit value exists in making the voltage distribution among the varistors even. When the cylindrical shield is used, in a varistor on a power supply side, a current flowing from the shield to the varistor is high compared to a current flowing to the ground tank, and there has been a problem that an overcompensated state in which the voltage stress is too small compared to a voltage stress of other varistors is generated.

It is an object of the present invention to solve the conventional problems described above, and to provide a lightning arrester that has a shield in a simple shape, and in such a shape that achieves more even voltage distribution among varistors than the conventional techniques.

### Solution to Problem

A lightning arrester according to an aspect of the present invention has layered varistors in a tank in which an insulating medium is filled, and a cylindrical shield is arranged therearound. To solve the problems described above, in the lightning arrester according to the present invention, a plurality of holes are arranged on a side surface of the shield.

### ADVANTAGEOUS EFFECTS OF INVENTION

According to the tank-type lightning arrester of the present invention, using a shield in a simple shape, more even voltage distribution among varistors can be achieved than the conventional techniques. As a result, the enhancement of performance of a lightning arrester can be achieved.

### BRIEF DESCRIPTION OF DRAWINGS

FIG. 1 is a side view showing a configuration according to a first embodiment of the present invention.

FIG. 2 is a plot of voltage distribution rate according to the first and a second embodiments of the present invention.

FIG. 3 is a side view showing a configuration according to the second embodiment of the present invention.

FIG. 4 is a horizontal section view showing the configuration according to the second embodiment of the present invention.

FIG. 5 is a side view showing a configuration according to a third embodiment of the present invention.

FIG. 6 is a cross-section showing the configuration according to the third embodiment of the present invention.

FIG. 7 is a detailed drawing of the third embodiment of the present invention.

FIG. 8 is a side view showing a configuration according to a fourth embodiment of the present invention.

FIG. 9 is a plot of voltage distribution rate according to the fourth embodiment of the present invention.

FIG. 10 is a side view showing a configuration according to a fifth embodiment of the present invention.

FIG. 11 is a horizontal section view showing the configuration according to the fifth embodiment of the present invention.

FIG. 12 is a plot of voltage distribution rate according to the fifth embodiment of the present invention.

FIG. 13 is a side view showing a configuration according to a sixth embodiment of the present invention.

### DESCRIPTION OF EMBODIMENTS

### First Embodiment

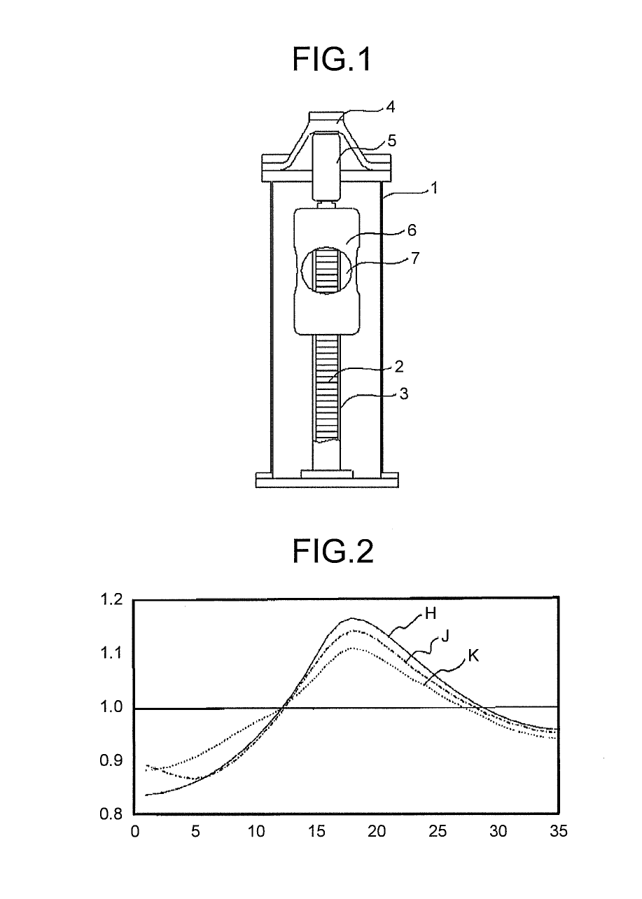

FIG. 1 is a side view showing a configuration according to a first embodiment of the present invention. An illustration observing an inside of a tank from a side thereof by removing a part of an outer wall of the tank of a lightning arrester is shown. As for a varistor, an example using a zinc oxide varistor is shown. A zinc oxide varistor has characteristics close to a volt-ampere characteristic of an ideal characteristic element, and is widely used. Inside a tank 1 in which an insulating medium is filled, a plurality of zinc oxide varistors 2 are supported by an insulation cylinder 3 and layered in series forming a single column. An upper end of the zinc oxide varistors 2 on a power supply side is connected to a main circuit conductor through a high-voltage side conductor 5 that is supported by an insulating spacer 4, and a lower end of the zinc oxide varistors 2 on a low voltage side is connected to a ground potential part. Further, a cylindrical shield 6 is placed on the power supply side of the zinc oxide varistors.

In the cylindrical shield 6 shown in FIG. 1, circular holes 7 are arranged on a side surface. Note that as for the shape of the holes, shapes other than a circular shape, such as an oval and a rectangle, are also applicable to an embodiment of the present invention. Although in the example shown in FIG. 1, the number of holes arranged in the shield is four, the different number of holes is also applicable to an embodiment of the present invention. However, as for the number of holes, it is preferable that more than one hole be arranged such that an electric field between the cylindrical shield and a ground tank is symmetrical with respect to a tank center line, not to be nonuniform.

FIG. 2 is a plot of voltage distribution rate according to the first and a second embodiments of the present invention. A horizontal axis indicates a position of a varistor, and a left end is the power supply side and a right end is the ground side. A vertical axis indicates a voltage distribution rate. By arranging holes in the cylindrical shield 6, it is possible to make the amounts of a current flowing to the ground tank 1 from the zinc oxide varistors 2 and a current flowing to the zinc oxide varistors 2 from the cylindrical shield 6 approximate to each other. As a result, compared to a case where a cylindrical shield without a hole is placed, overcompensation of current to the zinc oxide varistor 2 on the power supply side can be prevented. The voltage distribution rates of zinc oxide varistors of the lightning arrester according to the first embodiment shown in FIG. 1, and a lightning arrester in which a cylindrical shield without a hole is placed are as indicated by an alternate long and short dashed line J and a solid line H in FIG. 2, respectively. Note that it is indicated that the voltage distribution rate is more uniform as the value approaches 1. The voltage distribution of the lightning arrester in which the holes are arranged in the shield shown in FIG. 1 can prevent overcompensation of current flowing to the zinc oxide varistors compared to a lightning arrester in which no holes are arranged in a shield, and therefore, approximately 2% reduction can be expected in the maximum voltage distribution rate. The amount of current flowing to the ground tank from the zinc oxide varistors can be adjusted by the size of the holes to be arranged in the cylindrical shield. From this fact, by arranging a hole in a shield, such an effect can be expected that the voltage distribution among zinc oxide varistors is made even compared to a conventional case in which no holes are arranged in a shield.

Therefore, according to the tank-type lightning arrester of the first embodiment, using a shield in a simple shape, a voltage distributed among varistors can be made more even than the conventional techniques. As a result, the enhancement of performance of a lightning arrester can be achieved.

### Second Embodiment

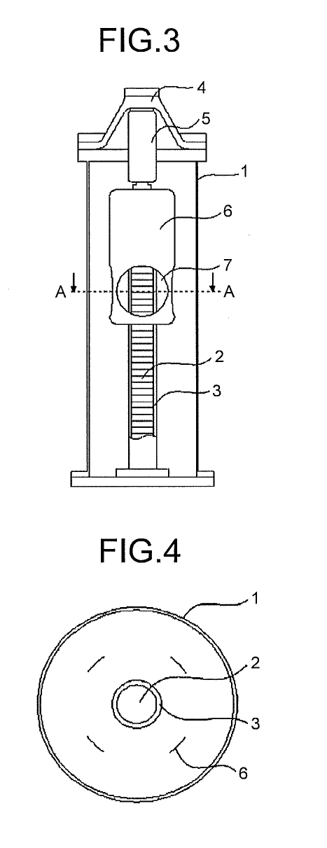

FIG. 3 is a side view showing a configuration according to the second embodiment of the present invention. An illustration observing an inside of a tank from a side thereof by removing a part of an outer wall of the tank of a lightning arrester is shown. FIG. 4 is a horizontal section view showing the configuration according to the second embodiment of the present invention. FIG. 4 is a horizontal section of FIG. 3 taken along a line A-A and viewed in the direction of arrow. On a side surface of the cylindrical shield 6, a plurality of the holes 7 are arranged at regular intervals.

The position of a zinc oxide varistor to be overcompensated can be adjusted by adjusting the positions of the holes in the cylindrical shield. Accordingly, to achieve more even voltage distribution, the positions of the holes are preferable to be at a lower portion of the shield as shown in FIG. 4. The position of the holes and a distribution of the voltage distribution can be obtained by a three-dimensional electric-field analysis simulation.

The voltage distribution rates of zinc oxide varistors of the lightning arrester according to the second embodiment shown in FIGS. 3 and 4, and a lightning arrester in which a cylindrical shield without a hole is placed are as indicated by a broken line K and the solid line H in FIG. 2, respectively. Note that it is indicated that the voltage distribution rate is more uniform as the value approaches 1. The voltage distribution of the lightning arrester shown in FIGS. 3 and 4 in which the holes are arranged in the shield can prevent overcompensation of a current flowing to the zinc oxide varistors compared to a lightning arrester in which no holes are arranged in a shield, and therefore, approximately 5% reduction can be expected in the maximum voltage distribution rate. Moreover, not just the positions of the holes in the cylindrical shield, the distribution of voltage distribution can be compensated by changing the diameter of a hole, by arranging multiple holes having different diameters, or by varying the density of holes depending on a position in the cylindrical shield. Positions, types, and density of holes and the distribution of voltage distribution in the respective cases can be obtained by three-dimensional electric-field analysis simulation.

As described above, by not just arranging a hole in the cylindrical shield, but also optimizing the position, the size, and the density of the holes, it is possible to make the voltage distribution among varistors more even by using a shield in a simple shape. As a result, the enhancement of performance of a lightning arrester can be achieved.

### Third Embodiment

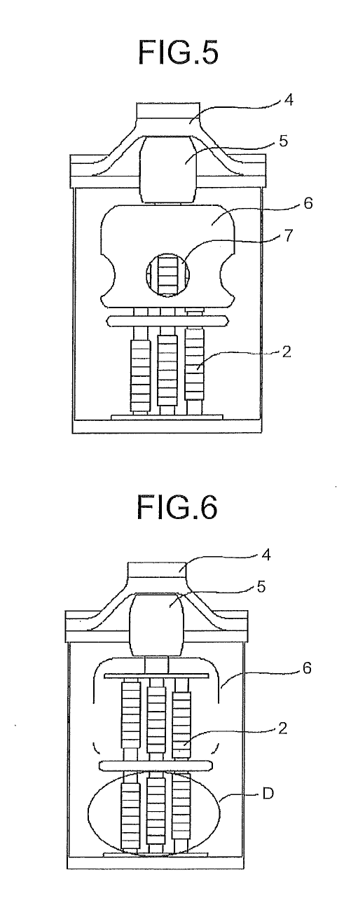

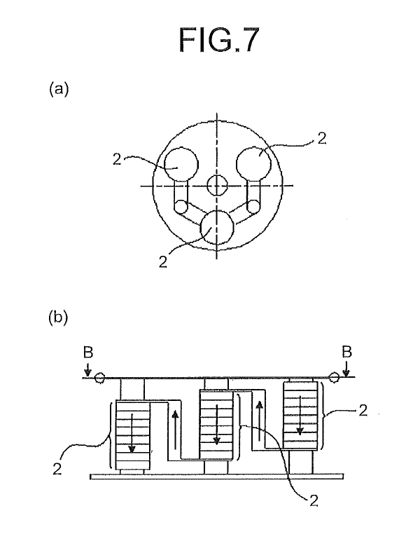

FIG. 5 is a side view showing a configuration according to a third embodiment of the present invention. FIG. 5 illustrates the third embodiment of the present invention when the zinc oxide varistors are layered in 10, series forming three columns. An illustration observing an inside of a tank from a side thereof by removing a part of an outer wall of the tank of a lightning arrester is shown. FIG. 6 is a cross-section showing the configuration according to the third embodiment of the present invention. An illustration observing, from a side, a state in which the zinc oxide varistors are layered forming three columns inside a cylindrical shield by removing a part of the shield of a lightning arrester is shown. FIG. 7 is a detailed drawing of the third embodiment of the present invention. A detailed partial view in which D-portion shown in FIG. 6 is enlarged and developed is shown in (b), and a horizontal section view horizontally cut along a line B-B is shown in (a). In FIG. 7(b), the route of current flowing from the power supply side to the ground side is indicated by arrows.

As the third embodiment, by arranging a plurality of layered columns of varistors, and by connecting the varistors in series, a lightning arrester that withstands high voltage while being compact can be achieved. Furthermore, by surrounding a plurality of the layered columns of the varistors with the cylindrical shield in which holes are arranged, it is possible to make the voltage distribution among the varistors even. As a result, downsizing, reduction of costs, and enhancement of performance of a lightning arrester can be achieved.

### Fourth Embodiment

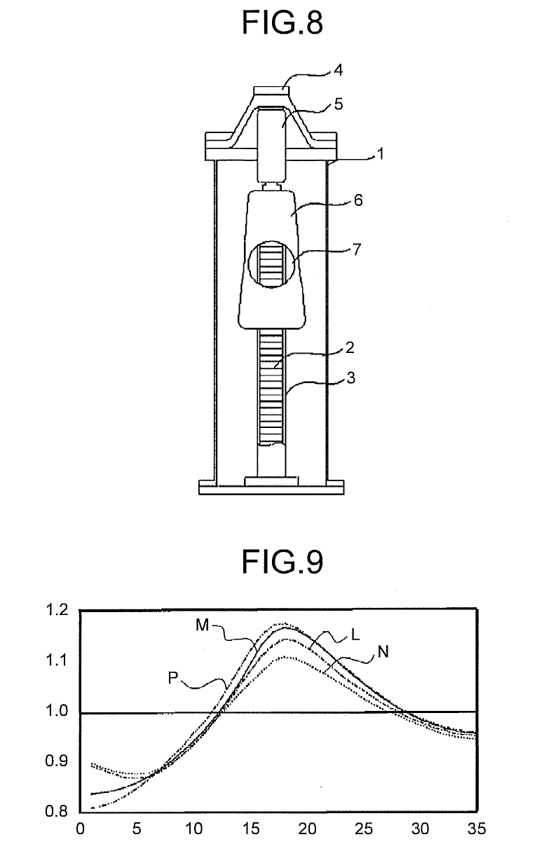

FIG. 8 is a side view showing a configuration according to a fourth embodiment of the present invention. An illustration observing an inside of a tank from a side thereof by removing a part of an outer wall of the tank of a lightning arrester is shown. As for a varistor, an example using a zinc oxide varistor is shown. A zinc oxide varistor has characteristics close to a volt-ampere characteristic of an ideal characteristic element, and is widely used. Inside the tank 1 in which an insulating medium is filled, a plurality of the zinc oxide varistors 2 are supported by the insulation cylinder 3 and layered in series forming a single column. For better understanding, an illustration observing an inside of the insulation cylinder 3 from a side thereof by removing a part of a wall of the insulation cylinder is shown. An upper end of the zinc oxide varistors 2 on a power supply side is connected to a main circuit conductor through the high-voltage side conductor 5 that is supported by the insulating spacer 4, and a lower end of the zinc oxide varistors 2 on a low voltage side is connected to a ground potential part. Further, the cylindrical shield 6 coaxial with the zinc oxide varistors is placed on the power supply side of the zinc oxide varistors.

In the cylindrical shield 6 shown in FIG. 8, the circular holes 7 are arranged on a side surface. Note that as for the shape of the holes, shapes other than a circular shape, such as an oval and a rectangle, are also applicable to an embodiment of the present invention. The shield 6 shown in FIG. 8 has a shape of truncated cone. The tank diameter of this case is identical to that of the cylindrical case shown in FIG. 1. As for the shape of the shield, a partially truncated-conical shape as shown in FIG. 8, or a shape adopting a conical shape is also applicable to an embodiment of the present invention. A shield in a cylindrical shape, a truncated conical shape, or a combination of these shapes are easy to be assembled and is considered as a simple shape as an entire unit. The present invention is aimed to solve the conventional problems described above, and to provide a lightning arrester in which a shield in a simple shape and in such a shape that can achieve more even voltage distribution among varistors than the conventional techniques. On a side surface of the shield 6, a plurality of the holes 7 are arranged at regular intervals. Although in the example shown in FIG. 8, the number of holes arranged in the shield is four, the different number of holes is also applicable to an embodiment of the present invention. However, as for the number of holes, it is preferable that a plurality of holes be arranged such that an electric field between the shield and a ground tank is not to be nonuniform.

By arranging holes in the shield 6 as shown in FIG. 8, it is possible to make the amounts of a current flowing to the ground tank 1 from the zinc oxide varistors 2 through the holes of the shield and a current flowing to the zinc oxide varistors 2 from the shield 6 approximate to each other. As a result, overcompensation of the zinc oxide varistor 2 on the power supply side can be prevented. The amount of current flowing to the ground tank from the zinc oxide varistors through the holes of the shield can be adjusted by adjusting the size of the holes to be arranged in the shield. From this fact, by arranging a hole in a shield, such an effect can be expected that the voltage distribution among the zinc oxide varistors are made more even compared to a conventional case in which no holes are arranged in a shield.

As for the shape of the shield, if a hole is not arranged in the shield, the varistor on the power supply side is more overcompensated in a truncated conical shape than in a cylindrical shape as shown in FIG. 1, and accordingly, the voltage distribution among the zinc oxide varistors is to be uneven. On the other hand, when a hole is arranged in the shield, the amount of current charged from the shield to the zinc oxide varistors is more approximated to the amount of current flowing from the zinc oxide varistors to the tank through the hole of the shield, and accordingly, the voltage distribution among the zinc oxide varistors is to be more even.

FIG. 9 is a plot of voltage distribution rate according to the fourth embodiment of the present invention. A horizontal axis indicates a position of a varistor, and a left end is the power supply side and a right end is the ground side. A vertical axis indicates a voltage distribution rate. The voltage distribution rates of zinc oxide varistors of the lightning arrester in which the holes are arranged at the center of the cylindrical shield shown in FIG. 1, a lightning arrester in which no holes are arranged in the cylindrical shield shown in FIG. 1, a lightning arrester in which the holes are arranged at the central portion of the truncated conical shield shown in FIG. 8, and a lightning arrester in which no holes are arranged in the truncated conical shield shown in FIG. 8 are as indicated by an alternate long and short dashed line L, a solid line M, a broken line N, and an alternate long and two short dashed line P in FIG. 9, respectively. Note that it is indicated that the voltage distribution rate is more uniform as the value approaches 1. If a hole is not arranged in the shield, the varistor on the power supply side is more overcompensated in a truncated conical shape than in a cylindrical shape, and accordingly, the maximum voltage distribution rate increases by approximately 0.5% with respect to the case of the cylindrical shield without a hole. On the other hand, when the holes are arranged on a side of the truncated conical shield at a central portion, overcompensation of the zinc oxide varistor on the power supply side can be prevented, and accordingly, approximately 5% reduction can be expected in the maximum voltage distribution rate. The reduction amount of the lightning arrester in which the holes are arranged in the center of the cylindrical shield as shown in FIG. 1 is approximately 2% with respect to the case of the cylindrical shield without a hole. Therefore, as the shape of the shield when a hole is arranged in the shield, the truncated conical shape is more effective. As for influences of the size of holes, the shield diameter, and the like on the voltage distribution, an optimal value can be obtained by a three-dimensional electric-field analysis simulation and verified by experiments.

### Fifth Embodiment

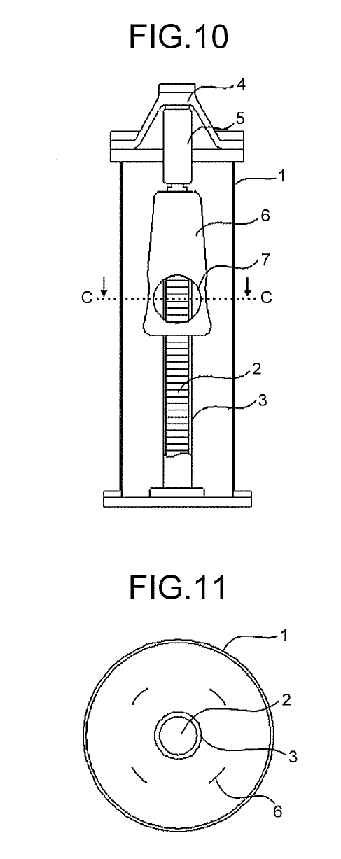

FIG. 10 is a side view showing a configuration according to a fifth embodiment of the present invention. FIG. 11 is a horizontal section view obtained by cutting FIG. 10 along a line C-C and viewed in the direction of arrow. On a side surface of the shield 6, a plurality of the holes 7 are arranged at regular intervals.

The amount of current flowing to the ground tank from the zinc oxide varistors through the holes of the shield can be adjusted by adjusting the size of the holes to be arranged in the shield. Moreover, the position of a zinc oxide varistor to be overcompensated can be adjusted by adjusting the positions of the holes in the shield. Accordingly, to achieve even voltage distribution more efficiently, the positions of the holes are preferable to be at a lower portion of the shield as shown in FIG. 10. The position of the holes and a distribution of the voltage distribution can be obtained by a three-dimensional electric-field analysis simulation.

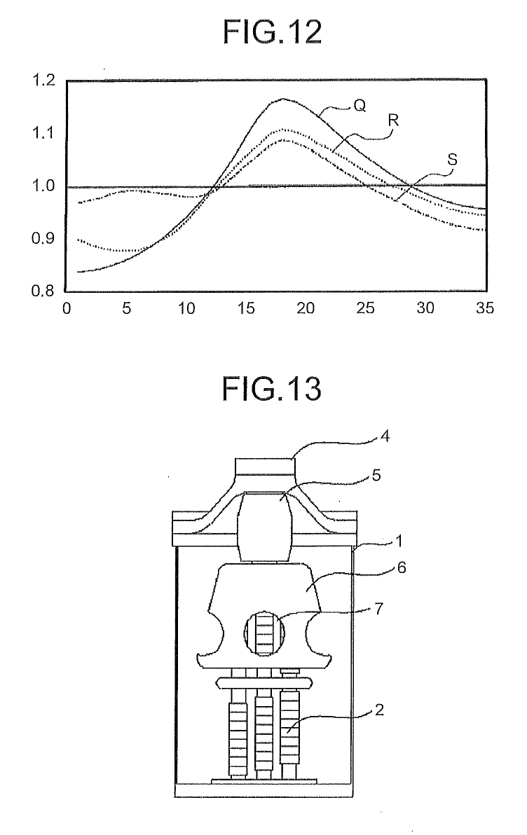

FIG. 12 is a plot of voltage distribution rate according to the fifth embodiments of the present invention. A horizontal axis indicates a position of a varistor, and a left end is the power supply side and a right end is the ground side. A vertical axis indicates a voltage distribution rate. The voltage distribution rates of zinc oxide varistors of the lightning arrester in which no holes are arranged in the cylindrical shield shown in FIG. 1, the lightning arrester in which the holes are arranged at the central portion of the truncated conical shield shown in FIG. 8, and a lightning arrester in which the holes are arranged at a lower portion of the truncated conical shield shown in FIG. 10 are as indicated by a solid line Q, a broken line R, and an alternate long and short dashed line S in FIG. 12, respectively. When the holes are arranged at a lower portion of the shield as shown in FIG. 10, the maximum voltage distribution rate can be lowered by approximately 7% with respect to the case of the cylindrical shield without a hole. The reduction amount of the lightning arrester in which the holes are arranged in the center of the truncated conical shield as shown in FIG. 8 is approximately 5%. From this fact, as for the position of the holes to be arranged on a side of the shield, a lower portion side as shown in FIG. 10 is more effective.

### Sixth Embodiment

FIG. 13 is a side view showing a configuration according to a sixth embodiment of the present invention. FIG. 13 illustrates the sixth embodiment of the present invention when the zinc oxide varistors are layered forming three columns.

As the sixth embodiment, by arranging a plurality of layered columns of varistors and connecting these columns in series, a lightning arrester that withstands high voltage while being compact can be achieved. Furthermore, by surrounding a plurality of the layered columns of varistors with a truncated conical shield with holes, it is possible to make the voltage distribution among the varistors even. As a result, downsizing, reduction of costs, and enhancement of performance of a lightning arrester can be achieved.

Because the shield described in the first to the sixth embodiments is obtained just by making a hole in the shield in a cylindrical shape or a truncated conical shape, the enhancement of performance can be achieved with a shield in a simple shape. Because the shield in a cylindrical shape or a truncated conical shape can be formed with a small number of parts, the enhancement of performance of a lightning arrester can be achieved advantageously in terms of cost and quality also.

### REFERENCE SIGNS LIST

1 TANK
2 ZINC OXIDE VARISTOR
3 INSULATION CYLINDER
6 CYLINDRICAL SHIELD
7 HOLE

1. A tank-type lightning arrester comprising:
a tank in which insulating medium is filled;
layered varistors that are housed in the tank; and
a cylindrical shield that is placed around the layered varistors in the tank, and in which a plurality of holes that are at most four holes are arranged on a side surface on a side surface at a portion that is biased to one side of the cylindrical shield in an axial direction of the cylindrical shield in a circumferential direction.

2. (canceled)

3. The tank-type lightning arrester according to claim 1, wherein
the layered varistors are arranged in a plurality of columns in parallel to each other, and are connected in series.

4. The tank-type lightning arrester according to claim 1, wherein
a shape of the shield is truncated cone.

5. The tank-type lightning arrester according to claim 3, wherein a shape of the shield is truncated cone.
